(19) United States
(12) Patent Application Publication
(10) Pub. No.: US 2010/0279713 A1
(43) Pub. Date: Nov. 4, 2010

(54) METHOD AND APPARATUS FOR LOCATION SHARING AS A FUNCTION OF TIME AND LOCATION

(75) Inventor: RONALD ANTHONY DICKE, OTTAWA (CA)

Correspondence Address: Smart & Biggar, P.O.Box 2999, Station D, 900-55 Metcalfe Street, Ottawa, ON, K1P 5Y6, CA

(73) Assignee: RESEARCH IN MOTION LIMITED, WATERLOO (CA)

(21) Appl. No.: 12/432,428

(22) Filed: Apr. 29, 2009

(51) Int. Cl. H04W 4/02; H04M 1/00

(52) U.S. Cl. 455/457; 455/550.1

(57) ABSTRACT

Provided is a method and apparatus for location sharing as a function of time and location. Privacy can be a concern when providing location information. Existing rules for location sharing are typically limited to either allowing or not allowing a user to obtain location information. In accordance with an embodiment of the disclosure, location sharing for a mobile device can be limited based on time and location of the mobile device. For example, location information of the mobile device might be provided to another device only during regular business hours when the mobile device is in a vicinity of an office site. Thus, the mobile device does not share its location information with the other device outside of business hours or when the mobile device is not in the vicinity of the office site.

### FIELD OF THE DISCLOSURE

The application relates to mobile devices, and more particularly to location sharing.

### BACKGROUND

A location-based service (LBS) is an information and entertainment service that makes use of the geographical position of one or more mobile devices. Some applications involve tracking the geographic location of one or more mobile devices. In order for a communication device to track the location of a mobile device, the communication device receives location information from which the geographical location of the mobile device can be determined. The location information can be generated by the mobile device using GPS technology or by other means. The communication device can receive location information on an ongoing basis in order to keep up to date on the geographical location of the mobile device.

There are existing approaches that allow a person to either share their information with everyone in their buddy/contact list or with no one. Privacy can be a concern when providing location information. One approach is implement permissions for accessing location information. This can prevent unauthorised users from accessing location information of a mobile device, as only authorised users can access the location information.

### BRIEF DESCRIPTION OF THE DRAWINGS

Embodiments will now be described with reference to the attached drawings in which:

FIG. 1 is a block diagram of an example communication system featuring peer-to-peer location sharing;

FIG. 2 is a block diagram of an example communication system featuring server-based location sharing;

FIG. 3 is a flowchart of a method of sharing location information of a mobile device as a function of time and location of the mobile device;

FIG. 4 is a flowchart of a method of sharing location information of a mobile device as a function of time and proximity of the mobile device to a location of interest;

FIG. 5 is a flowchart of a method of sharing location information of a mobile device as a function of time and proximity of the mobile device to another device;

FIG. 6 is a flowchart of a method of a mobile device sharing its location information in accordance with a set of rules;

FIG. 7 is a flowchart of a method of a server sharing location information of a mobile device in accordance with a set of rules; and

FIG. 8 is a block diagram of a mobile device.

### DETAILED DESCRIPTION OF EMBODIMENTS

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

According to a broad aspect, there is provided a method comprising: determining location information of a mobile device; determining based on time and location of the mobile device whether to share the location information with at least one other device; and sharing the location information with the at least one other device if so determined.

According to another broad aspect, there is provided a computer readable medium having computer executable instructions stored thereon for execution on a processor of a mobile device or a server so as to implement the method as summarised above.

According to another broad aspect, there is provided a mobile device comprising: a wireless access radio; a processor; and a time and location-based location sharer configured for: determining location information of a mobile device; determining based on time and location of the mobile device whether to share the location information with at least one other device; and sharing the location information with the at least one other device if so determined.

According to another broad aspect, there is provided a server comprising: a processor; and a time and location-based location sharer configured for: determining location information of a mobile device; determining based on time and location of the mobile device whether to share the location information with at least one other device; and sharing the location information with the at least one other device if so determined.

Other aspects and features of the present disclosure will become apparent, to those ordinarily skilled in the art, upon review of the following description of the specific embodiments of the invention.

### Systems for Location Sharing

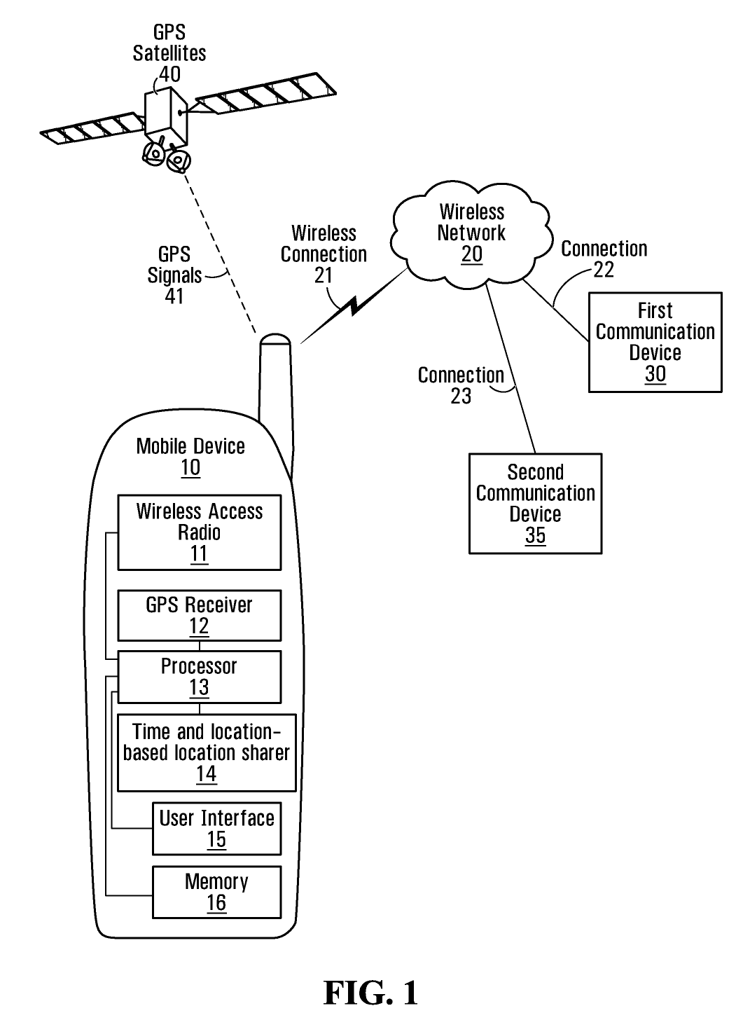

Turning now to FIG. 1, shown is a block diagram of an example communication system featuring peer-to-peer location sharing. The communication system has a wireless network 20, and a plurality of devices 10,30,35 including a mobile device 10 and other communication devices 30,35. There might be other devices, but they are not shown for simplicity. The mobile device 10 has a wireless access radio 11, a GPS receiver 12, a processor 13, a time and location-based location sharer 14, a user interface 15, a memory 16, and might have other components but they are not shown for simplicity. Details of the other communication devices 30,35 are omitted for simplicity. There are a plurality of GPS satellites 40 (only one shown for simplicity) for those devices that are GPS-enabled, for example the mobile device 10.

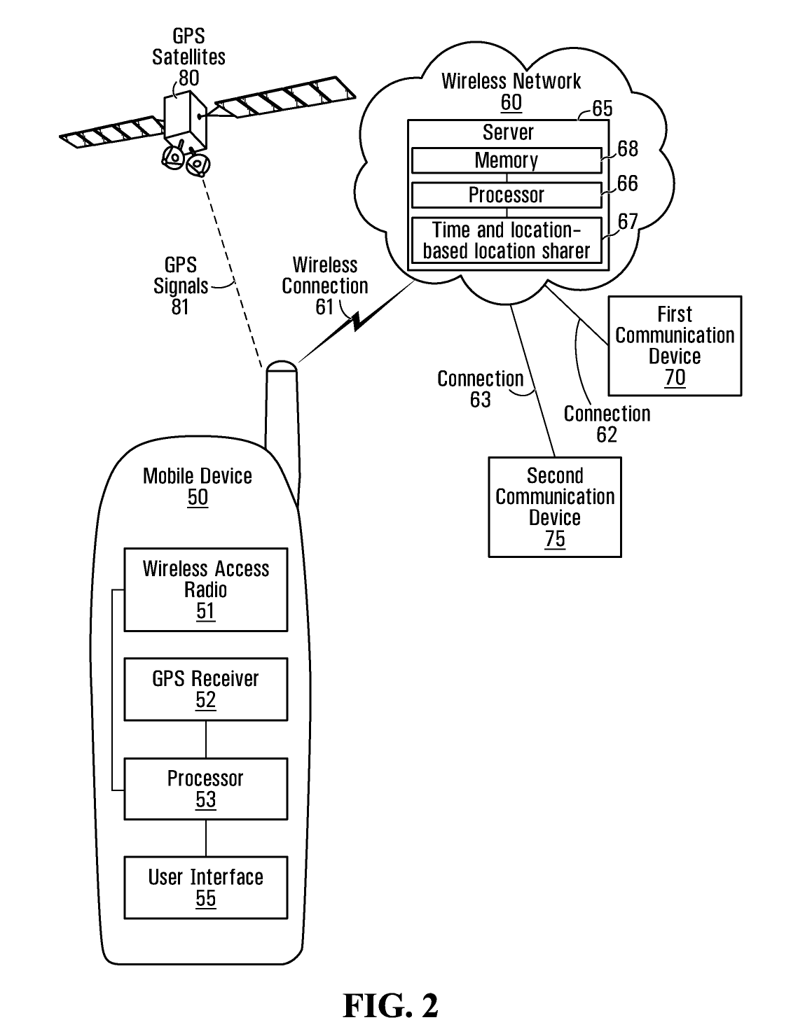

The operation of the communication system will now be described by way of example. Communication between the devices 10,30,35 is through the wireless network 20. The mobile device 10 uses its wireless access radio 11 for communicating wirelessly over a wireless connection 21, while the other communication devices 30,35 communicate over respective connections 22,23. The connections 22,23 can be wireless or wired depending on whether the communication devices 30,35 are mobile. For this example, it is assumed that the communication between the devices 10,30,35 is performed in a peer-to-peer manner. However, alternative implementations are possible. An example featuring communication in a server-based manner is described later with reference to FIG. 2.

The mobile device 10 generates location information using GPS technology, which involves receiving GPS signals 41 from the GPS satellites 40 using its GPS receiver 12. Location sharing involves the mobile device 10 sending the location information to another device, for example one of the other communication devices 30,35. This can allow another device to track the geographic location of the mobile device 10.

Privacy can be a concern when providing the location information. One approach is to implement permissions for accessing the location information. For example, the user might have a set of rules indicating who can see access their location information. However, existing rules for location sharing are typically limited to either allowing or not allowing a user to obtain location information. This can be rather limiting in certain scenarios. For example, if the user of the mobile device 10 is an employee and the user of the first communication device 30 is the employee's employer who wishes to keep track of each employee during regular business hours, then the location of the mobile device 10 should be provided to the first communication device 30 only during regular business hours. Whilst the first communication device 30 might monitor the mobile device 10 for business-related issues (e.g. arrival at the office site, location during the work day, departure from the office site, etc.), the employee should not have to disclose his whereabouts on evenings and weekends. Also, if the employee is out of the office during normal business hours, for example because he is on vacation, then the employee again should not have to disclose his whereabouts. Existing rules for location sharing simply do not account for these privacy considerations.

In accordance with an embodiment of the disclosure, the time and location-based location sharer 14 implements a method for sharing location information of the mobile device 10 as a function of time and location of the mobile device 10. For the employee example described above, the location information of the mobile device 10 might be provided to the first communication device 30 only during regular business hours when the mobile device 10 is in a vicinity of the office or the first communication device 30. Thus, the mobile device 10 does not share its location information with the first communication device 30 outside of business hours or when the mobile device 10 is not in the vicinity of the office or the first communication device 30. This can give the user of the mobile device 10 peace of mind that his employer is not tracking his location during evenings and weekends or when out of the office on vacation for example. Location might also be shared with other devices with or without this sort of restriction.

In some implementations, the time and location-based location sharer 14 can be configured by the user using the user interface 15. In some implementations, the user interface 15 is configured to allow the user to define a set of rules for sharing location information as a function of time and location of the mobile device 10. The time and location-based location sharer 14 is configured for sharing the location information in accordance with the set of rules. In some implementations, the set of rules are stored in the memory 16 of the mobile device 10. However, alternative implementations are possible. An example in which a set of rules are stored on a server so that the server can perform the location sharing in accordance with the set of rules is provided below with reference to FIG. 2.

Therefore, in some implementations, a set of rules can be configured for establishing permissions that not only allow location information to be shared with specified individual users, but as a function of time, space and/or proximity. Each user can have different rules for sharing location information. Note that location might be shared with some users without any restriction of time or location. Restrictions can be imposed on a per user basis. In specific implementations, there is a respective location sharing rule for each of a plurality of user. Other implementations are possible.

In the illustrated example, the time and location-based location sharer 14 is implemented as software and is executed on the processor 13. However, more generally, the time and location-based location sharer 14 may be implemented as software, hardware, firmware, or any appropriate combination thereof.

It is to be understood that embodiments of the disclosure are similarly applicable to server-based communication between the devices 10,30,35. For server-based implementations, the mobile device can perform the location sharing as a function of time and location of the mobile device as similarly described above. The server might for example operate as a conduit for the location information, or alternatively the server itself can perform the location sharing as a function of time and location of the mobile device. An example of this is described below with reference to FIG. 2.

Turning now to FIG. 2, shown is a block diagram of an example communication system featuring server-based location sharing. The communication system has a wireless network 60, and a plurality of devices 50,30,35 including a mobile device 50 and other communication devices 70,75. There might be other devices, but they are not shown for simplicity. The mobile device 50 has a wireless access radio 51, a GPS receiver 52, a processor 53, a user interface 55, and might have other components but they are not shown for simplicity. Details of the other communication devices 70,75 are omitted for simplicity. The wireless network 60 has a server 65, which has a processor 66, a time and location-based location sharer 67, a memory 68, and might have other components but they are not shown for simplicity. The server 65 is shown to part of the wireless network 60. In alternative configurations, the server 65 does not form part of the wireless network 60 and is instead coupled to the wireless network 60. There are a plurality of GPS satellites 80 (only one shown for simplicity) for those devices that are GPS-enabled, for example the mobile device 50.

The operation of the communication system will now be described by way of example. Communication between the devices 50,70,75 is through the server 65 of the wireless network 60. The mobile device 50 uses its wireless access radio 51 for communicating wirelessly over a wireless connection 61, while the other communication devices 70,75 communicate over respective connections 62,63. The connections 62,63 can be wireless or wired depending on whether the communication devices 70,75 are mobile. For this example, it is assumed that the communication between the devices 50,70,75 is performed in a server-based manner.

The mobile device 50 generates location information using GPS technology, which involves receiving GPS signals 81 from the GPS satellites 80 using its GPS receiver 52. Location sharing involves the mobile device 50 sending the location information to the server 65, which in turn provides the location information to another device, for example one of the other communication devices 70,75. Location sharing can allow another device to track the geographic location of the mobile device 50.

In accordance with an embodiment of the disclosure, the time and location-based location sharer 67 implements a method for sharing the location information of the mobile device 50 as a function of time and location of the mobile device 50. The server 60 might automatically receive location information of the mobile device 50 on an ongoing basis, or receive the location information upon request. Regardless, the time and location-based location sharer 67 restricts location sharing based on time and location of the mobile device 50, as similarly described above for FIG. 1. Location might also be shared with other devices with or without this sort of restriction.

In some implementations, the time and location-based location sharer 67 can be configured by a remote user, for example by the user of the mobile device 50 using the user interface 55. The user might define a set of rules for sharing location information as a function of time and location of the mobile device 50. The time and location-based location sharer 67 is configured for sharing the location information in accordance with the set of rules. In some implementations, the set of rules are stored in the memory 68 of the server 65. However, alternative implementations are possible.

In the illustrated example, the time and location-based location sharer 67 of the server 65 is implemented as software and is executed on the processor 66. However, more generally, the time and location-based location sharer 67 may be implemented as software, hardware, firmware, or any appropriate combination thereof. In some implementations, the server 65 is a presence server.

In the illustrated examples present above with reference to FIG. 1 and FIG. 2, details of the wireless networks 20,60 have been omitted. It is to be understood that the wireless networks 20,60 would have any appropriate combination of components suitable for a wireless network. Note that the wireless networks 20,60 may include wires in spite of having components for wireless communication. The components of the wireless networks 20,60 are implementation specific and may depend on the type of wireless network. Any appropriately configured wireless network can be used. In specific implementations, the wireless networks 20,60 are GSM (Global System for Mobile communications)/EDGE (Enhanced Data rates for GSM Evolution)/3G or CDMA (Code Division Multiple Access) networks. In other implementations, the wireless networks 20,60 are WiFi networks. Other implementations are possible.

In the illustrated examples present above with reference to FIG. 1 and FIG. 2, it is assumed that at least some of the devices are GPS-enabled for determining geographic location. Whilst examples presented herein focus on use of GPS, it is to be understood that alternative means for determining geographic location are possible and are within the scope of this disclosure. For example, geographic location can alternatively be determined based on cell/sector identification within cellular network. As another example, geographic location can be determined using triangulation of signals from in-range base towers, such as those used for Wireless E911. Wireless Enhanced 911 services enable a cell phone or other wireless device to be located geographically using radiolocation techniques such as (i) angle of arrival (AOA) which entails locating the caller at the point where signals from two towers intersect; (ii) time difference of arrival (TDOA), which uses multilateration like GPS, except that the networks determine the time difference and therefore the distance from each tower; and (iii) location signature, which uses “fingerprinting” to store and recall patterns (such as multipath) which mobile phone signals exhibit at different locations in each cell. Coarser location information can be obtained not only be triangulating the device's position based on nearby cell towers but also based on nearby Wi-Fi access points via a WLAN radio. As an alternative example, geographic location can be determined based on bar codes. Each bar code is located in a predefined location and encodes location information for that location. A mobile device, upon scanning/taking picture of one of these bar codes, can obtain the location information. The bar codes can be 1-dimensional, or 2-dimensional. Other means for determining geographic location may be possible.

In the examples presented herein, reference is made to “location information” of a mobile device. It is to be understood that there are many possibilities for the location information. In specific implementations, the location information is presence information. In some implementations, the location information includes coordinates of the location of the mobile device. The coordinates might for example be derived using GPS technology. More generally, the location information includes any suitable information from which the location of the mobile device can be determined.

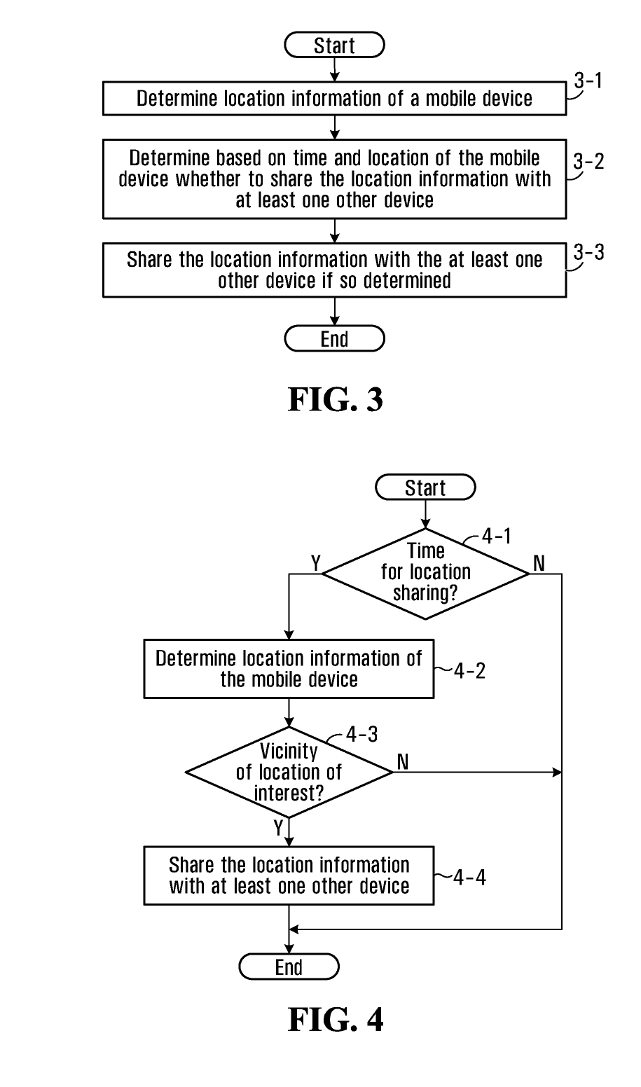

Further details of sharing location information of a mobile device as a function of time and location of the mobile device are provided below with reference to FIG. 3 through FIG. 7.

### Methods for Location Sharing

Referring now to FIG. 3, shown is a flowchart of a method of sharing location information of a mobile device as a function of time and location of the mobile device. This method may be implemented in a mobile device, for example by the time and location-based location sharer 14 of the mobile device 10 shown in FIG. 1. Alternatively, this method may be implemented in a server, for example by the time and location-based location sharer 67 of the server 65 shown in FIG. 2. More generally, this method may be implemented in any appropriately configured apparatus.

At step 3-1, the apparatus determines location information of a mobile device. At step 3-2, the apparatus determines based on time and location of the mobile device whether to share the location information with at least one other device. At step 3-3, the apparatus shares the location information with the at least one other device if so determined. Thus, the apparatus shares the location information with at least one other device as a function of time and location of the mobile device. For the employee example described above, the location information of the mobile device might be provided to another device only during regular business hours when the mobile device is in the vicinity of the office or the other device. Location information might also be shared with other devices with or without this sort of restriction.

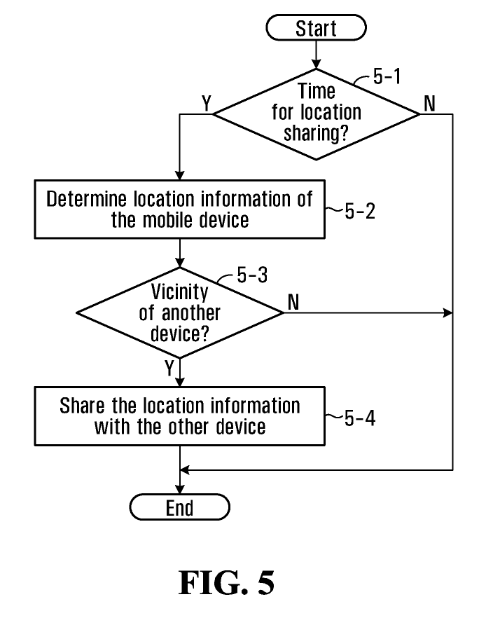

There are many ways in which location sharing for a mobile device can be restricted based on the location of the mobile device. In some implementations, location sharing for a mobile device is restricted based on the proximity of the mobile device to a location of interest (e.g. an office site). An example of this is described below with reference to FIG. 4. In other implementations, location sharing for a mobile device is restricted based on the proximity of the mobile device to another device (e.g. device of employer). An example of this is described below with reference to FIG. 5. Combinations might also possible (e.g. proximity of the mobile device to a location of interest and proximity of the mobile device to another device.

Referring now to FIG. 4, shown is a flowchart of a method of sharing location information of a mobile device as a function of time and proximity of the mobile device to a location of interest. This method may be implemented in a mobile device, for example by the time and location-based location sharer 14 of the mobile device 10 shown in FIG. 1. Alternatively, this method may be implemented in a server, for example by the time and location-based location sharer 67 of the server 65 shown in FIG. 2. More generally, this method may be implemented in any appropriately configured apparatus.

At step 4-1, the apparatus determines whether location sharing for a mobile device is permitted at the current time. If location sharing is permitted at the current time, then at step 4-2 the apparatus determines location information of the mobile device. At step 4-3, based on the location information determined, the apparatus determines whether the mobile device is in a vicinity of a location of interest. The location of interest might for example be an office site. If the mobile device is in the vicinity of the location of interest, then at step 4-4 the apparatus shares the location information with at least one other device. The at least one other device might for example include a communication device at the office site used for tracking the location of the mobile device.

There are many ways for the apparatus to determine whether location sharing is permitted at the current time. In some implementations, the apparatus determines whether the current time is within a predefined time schedule for location sharing. The predefined time schedule might for example be a schedule of normal business hours such as Monday through Friday between 9 am and 5 pm. For this specific example, location sharing is permitted only during the normal business hours. The predefined time schedule might be configured by the user of the mobile device, or simply pre-configured. Other implementations are possible.

There are many ways to determine whether the mobile device is in a vicinity of a location of interest. In some implementations, the location of the location of interest is defined by the user ahead of time. Thus, the apparatus can compare the location of location of interest with the present location of the mobile device. If they are less than a predefined amount, then the apparatus determines that the mobile device is in the vicinity of the location of interest. In some implementations, the location of interest is defined by a geofence. Thus, the apparatus can compare the present location of the mobile device to see if it falls within the geofence. If it does, then the apparatus determines that the mobile device is in the vicinity of the location of interest. Other implementations are possible.

In some implementations, location information is provided to the at least one other device when the mobile device becomes within or falls out of a predefined distance from the location of interest. For the employee example described above, the location information of the mobile device might be provided to another device whenever the mobile device arrives at work and whenever the mobile device leaves work. This can inform the employer as to when the employee arrives at work and leaves work. Location information might also be provided whenever the mobile device moves more than a specified distance while in the vicinity of the location of interest. For the employee example described above, if the employee is moving at the office site during the day, then any movement greater than the specified distance would cause an update of location information to the other device. The specified distance might be defined by a user, or pre-configured.

Referring now to FIG. 5, shown is a flowchart of a method of sharing location information of a mobile device as a function of time and proximity of the mobile device to another device. This method may be implemented in a mobile device, for example by the time and location-based location sharer 14 of the mobile device 10 shown in FIG. 1. Alternatively, this method may be implemented in a server, for example by the time and location-based location sharer 67 of the server 65 shown in FIG. 2. More generally, this method may be implemented in any appropriately configured apparatus.

At step 5-1, the apparatus determines whether location sharing for a mobile device is permitted at the current time. If location sharing is permitted at the current time, then at step 5-2, the apparatus determines location information of the mobile device. At step 5-3, based on the location information determined, the apparatus determines whether the mobile device is in a vicinity of another device. The other device might for example be a communication device at an office site used for tracking the location of the mobile device. If the mobile device is in the vicinity of the other device, then at step 5-4 the apparatus shares the location information with the other device. The apparatus might also share the location information with other devices. More generally, the apparatus shares the location information with at least one device including a particular device when the mobile device is in the vicinity of the particular device.

There are many ways to determine whether the mobile device is in a vicinity of the other device. In some implementations, the location of the other device is known ahead of time and is assumed to be stationary in the case that the other device is not mobile. Thus, the apparatus can compare the location of the other device with the present location of the mobile device. If they are less than a predefined amount, then the apparatus determines that the mobile device is in the vicinity of the other device. Other implementations are possible. If the other device is mobile, then the apparatus might request location information from the other device. Upon receiving the location information from the other device, the apparatus can determine whether the mobile device is in the vicinity of the other device. Other implementations are possible.

In some implementations, location information is provided to the other device when the mobile device becomes within or falls out of a predefined distance from the other device. For the employee example described above, the location information of the mobile device might be provided to the other device whenever the mobile device becomes in a vicinity of the other device (e.g. arrives at work site) and whenever the mobile device leaves vicinity of the other device (e.g. leaves work site). This can inform the employer as to when the employee arrives at work and leaves work. Location information might also be provided whenever the mobile device moves more than a specified distance while in the vicinity of the location of interest. For the employee example described above, if the employee is moving at the office site during the day, then any movement greater than the specified distance would cause an update of location information to the other device. The specified distance might be defined by a user, or pre-configured.

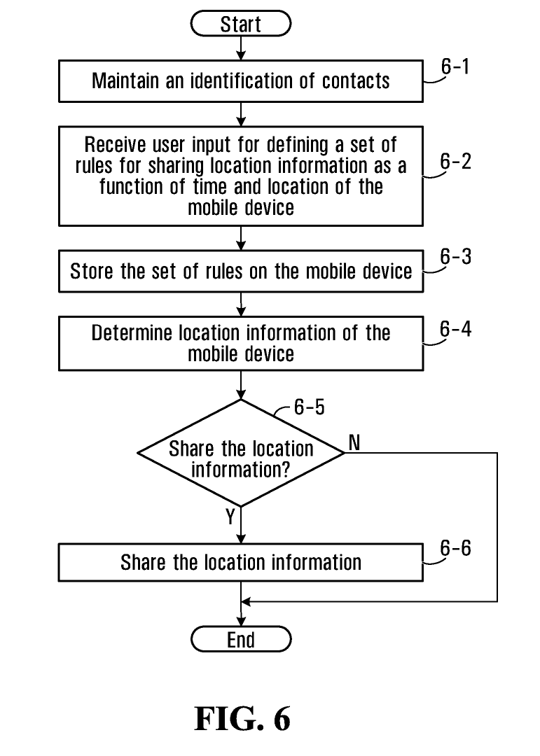

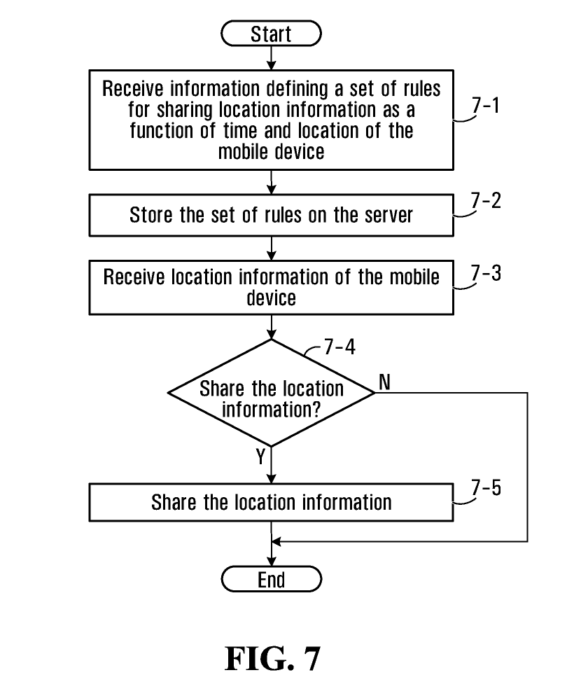

In some implementations, the location sharing is performed based on a set of rules. The set of rules can vary in terms of complexity for providing location information to other users depending on the criteria considered. In specific implementations, the set of rules specify permission to share location information based on any one or more of the following criteria:
Let person A know my location but not Person B
Let person A know my location at specified times
Let person A know my location when I am within or fallout of a certain distance of a specified location (e.g. work)
Let person A know my location if person A and I are within a certain distance or are farther apart than a certain distance
Notify person A that my location has changed after I have moved a certain distance
Notify person A that my location has changed if I enter/leave a defined geofence
Notify person A with my location using any combination of the above rules
   For peer-to-peer location sharing, the set of rules might be configured by the user and stored on the mobile device. An example of this is described below with reference to FIG. 6. For server-based location sharing, the set of rules might also be configured by the user and stored on the mobile device. Alternatively, for server-based location sharing, the set of rules might be configured by the user but stored on the server. An example of this is described below with reference to FIG. 7.

Referring now to FIG. 6, shown is a flowchart of a method of a mobile device sharing its location information in accordance with a set of rules. This method may be implemented in a mobile device, for example by the time and location-based location sharer 14 of the mobile device 10 shown in FIG. 1. More generally, this method may be implemented in any appropriately configured mobile device.

At step 6-1, the mobile device maintains an identification of contacts. This might for example be a buddy list or other list of contacts. At step 6-2, the mobile device receives user input for defining a set of rules concerning location sharing for at least one of the contacts. The rules might for example allow location sharing for some of the contacts while disallowing location sharing for other contacts. At least one of the rules limit location sharing for some of the contacts based on time and location of the mobile device. In some implementations, as indicated at step 6-3, the mobile device stores the set of rules on the mobile device.

At step 6-4, the mobile device determines location information of the mobile device. At step 6-5, the mobile device determines based on the set of rules whether to share the location information with at least one other device. If the mobile device determines based on the set of rules that the location information is to be shared with at least one other device, then at step 6-6 the mobile device shares the location information in accordance with the set of rules. Thus, location sharing with some of the contacts can be limited according to the rules based on time and location of the mobile device.

Referring now to FIG. 7, shown is a flowchart of a method of a server sharing location information of a mobile device in accordance with a set of rules. This method may be implemented in server, for example by the time and location-based location sharer 67 of the server 65 shown in FIG. 2. More generally, this method may be implemented in any appropriately configured server.

At step 7-1, the server receives information defining a set of rules for sharing location information as a function of time and location of the mobile device. In some implementations, this information is provided by the mobile device. In other implementations, this information is provided by another device. The rules might for example allow location sharing for some of the contacts while disallowing location sharing for other contacts. At least one of the rules limit location sharing for some of the contacts based on time and location of the mobile device. In some implementations, as indicated at step 7-2, the server stores the set of rules on the server.

At step 7-3, the server receives location information of the mobile device. At step 7-4, the server determines based on the set of rules whether to share the location information with at least one other device. If the server determines based on the set of rules that the location information is to be shared with at least one other device, then at step 6-6 the server shares the location information in accordance with the set of rules. Thus, location sharing can be limited according to the rules based on time and location of the mobile device.

### Another Mobile Device

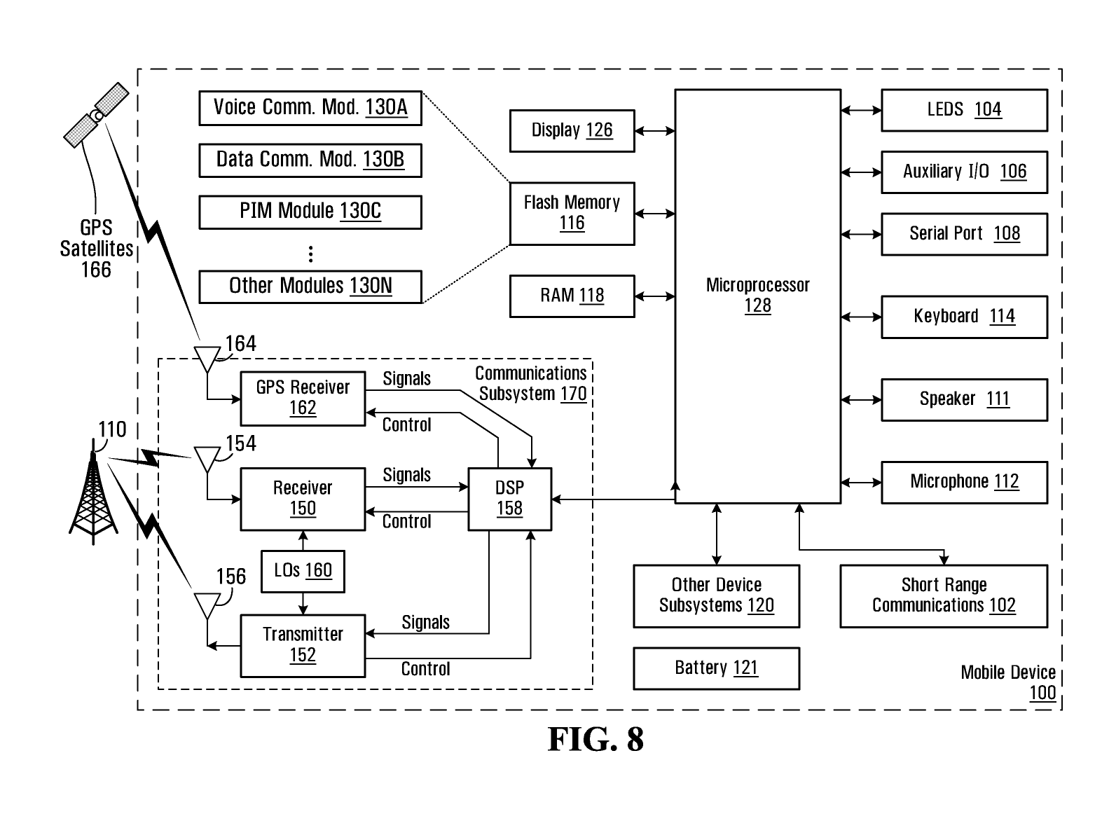

Referring now to FIG. 8, shown is a block diagram of another mobile device 100 that may implement any of the device methods described herein. The mobile device 100 is shown with specific components for implementing features similar to those of the mobile device 10 shown in FIG. 1. It is to be understood that the mobile device 100 is shown with very specific details for exemplary purposes only.

A processing device (a microprocessor 128) is shown schematically as coupled between a keyboard 114 and a display 126. The microprocessor 128 is a type of processor with features similar to those of the processor 13 of the mobile device 10 shown in FIG. 1. The microprocessor 128 controls operation of the display 126, as well as overall operation of the mobile device 100, in response to actuation of keys on the keyboard 114 by a user.

The mobile device 100 has a housing that may be elongated vertically, or may take on other sizes and shapes (including clamshell housing structures). The keyboard 114 may include a mode selection key, or other hardware or software for switching between text entry and telephony entry.

In addition to the microprocessor 128, other parts of the mobile device 100 are shown schematically. These include: a communications subsystem 170; a short-range communications subsystem 102; the keyboard 114 and the display 126, along with other input/output devices including a set of LEDs 104, a set of auxiliary I/O devices 106, a serial port 108, a speaker 111 and a microphone 112; as well as memory devices including a flash memory 116 and a Random Access Memory (RAM) 118; and various other device subsystems 120. The mobile device 100 may have a battery 121 to power the active elements of the mobile device 100. The mobile device 100 is in some embodiments a two-way radio frequency (RF) communication device having voice and data communication capabilities. In addition, the mobile device 100 in some embodiments has the capability to communicate with other computer systems via the Internet.

Operating system software executed by the microprocessor 128 is in some embodiments stored in a persistent store, such as the flash memory 116, but may be stored in other types of memory devices, such as a read only memory (ROM) or similar storage element. In addition, system software, specific device applications, or parts thereof, may be temporarily loaded into a volatile store, such as the RAM 118. Communication signals received by the mobile device 100 may also be stored to the RAM 118.

The microprocessor 128, in addition to its operating system functions, enables execution of software applications on the mobile device 100. A predetermined set of software applications that control basic device operations, such as a voice communications module 130A and a data communications module 130B, may be installed on the mobile device 100 during manufacture. In addition, a personal information manager (PIM) application module 130C may also be installed on the mobile device 100 during manufacture. The PIM application is in some embodiments capable of organizing and managing data items, such as e-mail, calendar events, voice mails, appointments, and task items. The PIM application is also in some embodiments capable of sending and receiving data items via a wireless network 110. In some embodiments, the data items managed by the PIM application are seamlessly integrated, synchronized and updated via the wireless network 110 with the device user's corresponding data items stored or associated with a host computer system. As well, additional software modules, illustrated as another software module 130N, may be installed during manufacture.

The flash memory 116 stores computer executable instructions for implementing features similar to those of the time and location-based location sharer 14 of the mobile device 10 shown in FIG. 1. In a specific implementation, the other module 130N of the flash memory 116 stores computer executable instructions that when executed implement a time and location-based location sharer. Note that the implementations described with reference to FIG. 8 are very specific for exemplary purposes.

Communication functions, including data and voice communications, are performed through the communication subsystem 170, and possibly through the short-range communications subsystem 102. The communication subsystem 170 includes a receiver 150, a transmitter 152, a GPS receiver 162, and one or more antennas, illustrated as a receive antenna 154 and a transmit antenna 156, and a GPS antenna 164. In addition, the communication subsystem 170 also includes a processing module, such as a digital signal processor (DSP) 158, and local oscillators (LOs) 160. The communication subsystem 170 having the transmitter 152 and the receiver 150 is a wireless access radio with features similar to those of the wireless access radio 11 of the mobile device 10 shown in FIG. 1. The specific design and implementation of the communication subsystem 170 is dependent upon the communication network in which the mobile device 100 is intended to operate. For example, the communication subsystem 170 of the mobile device 100 may be designed to operate with the Mobitex™, DataTAC™ or General Packet Radio Service (GPRS) mobile data communication networks and also designed to operate with any of a variety of voice communication networks, such as Advanced Mobile Phone Service (AMPS), Time Division Multiple Access (TDMA), Code Division Multiple Access (CDMA), Personal Communications Service (PCS), Global System for Mobile Communications (GSM), etc. Examples of CDMA include 1X and 1x EV-DO. The communication subsystem 170 may also be designed to operate with an 802.11 Wi-Fi network, and/or an 802.16 WiMAX network. Other types of data and voice networks, both separate and integrated, may also be utilized with the mobile device 100.

Network access may vary depending upon the type of communication system. For example, in the Mobitex™ and DataTAC™ networks, mobile devices are registered on the network using a unique Personal Identification Number (PIN) associated with each device. In GPRS networks, however, network access is typically associated with a subscriber or user of a device. A GPRS device therefore typically has a subscriber identity module, commonly referred to as a Subscriber Identity Module (SIM) card, in order to operate on a GPRS network.

When network registration or activation procedures have been completed, the mobile device 100 may send and receive communication signals over the communication network 110. Signals received from the communication network 110 by the receive antenna 154 are routed to the receiver 150, which provides for signal amplification, frequency down conversion, filtering, channel selection, etc., and may also provide analog to digital conversion. Analog-to-digital conversion of the received signal allows the DSP 158 to perform more complex communication functions, such as demodulation and decoding. In a similar manner, signals to be transmitted to the network 110 are processed (e.g., modulated and encoded) by the DSP 158 and are then provided to the transmitter 152 for digital to analog conversion, frequency up conversion, filtering, amplification and transmission to the communication network 110 (or networks) via the transmit antenna 156.

In addition to processing communication signals, the DSP 158 provides for control of the receiver 150, the transmitter 152, and the GPS receiver 162. For example, gains applied to communication signals in the receiver 150 and the transmitter 152 may be adaptively controlled through automatic gain control algorithms implemented in the DSP 158.

In a data communication mode, a received signal, such as a text message or web page download, is processed by the communication subsystem 170 and is input to the microprocessor 128. The received signal is then further processed by the microprocessor 128 for an output to the display 126, or alternatively to some other auxiliary I/O devices 106. A device user may also compose data items, such as e-mail messages, using the keyboard 114 and/or some other auxiliary I/O device 106, such as a touchpad, a rocker switch, a thumb-wheel, or some other type of input device. The composed data items may then be transmitted over the communication network 110 via the communication subsystem 170.

In a voice communication mode, overall operation of the device is substantially similar to the data communication mode, except that received signals are output to a speaker 111, and signals for transmission are generated by a microphone 112. Alternative voice or audio I/O subsystems, such as a voice message recording subsystem, may also be implemented on the mobile device 100. In addition, the display 126 may also be utilized in voice communication mode, for example, to display the identity of a calling party, the duration of a voice call, or other voice call related information.

Location determination using GPS technology involves receiving GPS signals from GPS satellites 166 on the antenna 164. The GPS signals are received using the GPS receiver 162 and processed by the DSP 158. Typically, GPS signals from at least four satellites are processed. Further details of GPS are omitted for simplicity.

The short-range communications subsystem 102 enables communication between the mobile device 100 and other proximate systems or devices, which need not necessarily be similar devices. For example, the short range communications subsystem may include an infrared device and associated circuits and components, or a Bluetooth™ communication module to provide for communication with similarly-enabled systems and devices.

Numerous modifications and variations of the present disclosure are possible in light of the above teachings. It is therefore to be understood that within the scope of the appended claims, the disclosure may be practised otherwise than as specifically described herein.

We claim:

1. A method comprising:
determining location information of a mobile device;
determining based on time and location of the mobile device whether to share the location information with at least one other device; and
sharing the location information with the at least one other device if so determined.

2. The method of claim 1, wherein determining based on time and location of the mobile device whether to share the location information with at least one other device comprises:
determining whether location sharing with the at least one other device is enabled at a current time;
determining whether the mobile device is in a vicinity of a location of interest; and
determining that the location information is to be shared with the at least one other device only if the mobile device is in the vicinity of the location of interest and location sharing is enabled at the current time.

3. The method of claim 2, wherein sharing the location information with the at least one other device comprises:
providing an update for the location information whenever the mobile device moves more than a specified distance while in the vicinity of the location of interest.

4. The method of claim 1, wherein determining based on time and location of the mobile device whether to share the location information with at least one other device comprises:
determining whether location sharing with the at least one other device is enabled at a current time;
determining whether the mobile device is in a vicinity of a particular device of the at least one other device; and
determining that the location information is to be shared with the at least one other device only if the mobile device is in the vicinity of the particular device and location sharing is enabled at the current time.

5. The method of claim 4, wherein sharing the location information with the at least one other device comprises:
providing an update for the location information whenever the mobile device moves more than a specified distance while in the vicinity of the particular device.

6. The method of claim 1, wherein the method is executed in the mobile device.

7. The method of claim 6, further comprising:
receiving user input for defining a set of rules for sharing the location information as a function of time and location of the mobile device;
wherein determining based on time and location of the mobile device whether to share the location information with at least one other device comprises:
determining based on the set of rules whether to share the location information with the at least one other device.

8. The method of claim 7, further comprising:
maintaining an identification of a plurality of contacts;
wherein receiving user input for defining a set of rules comprises receiving user input for defining a set of rules concerning location sharing for at least one of the plurality of contacts.

9. The method of claim 7, further comprising:
storing the set of rules on the mobile device.

10. The method of claim 1, wherein the method is executed in a server.

11. The method of claim 10, further comprising:
receiving information defining a set of rules for sharing the location information as a function of time and location of the mobile device; and
storing the set of rules on the server;
wherein determining based on time and location of the mobile device whether to share the location information with at least one other device comprises:
determining based on the set of rules whether to share the location information with the at least one other device.

12. A computer readable medium having computer executable instructions stored thereon for execution on a processor of a mobile device or a server so as to implement the method of claim 1.

13. A mobile device comprising:
a wireless access radio;
a processor; and
a time and location-based location sharer configured for:
determining location information of a mobile device;
determining based on time and location of the mobile device whether to share the location information with at least one other device; and
sharing the location information with the at least one other device if so determined.

14. The mobile device of claim 13, wherein the time and location-based location sharer is configured for determining based on time and location of the mobile device whether to share the location information with at least one other device by:
determining whether location sharing with the at least one other device is enabled at a current time;
determining whether the mobile device is in a vicinity of a location of interest; and
determining that the location information is to be shared with the at least one other device only if the mobile device is in the vicinity of the location of interest and location sharing is enabled at the current time.

15. The mobile device of claim 13, wherein the time and location-based location sharer is configured for determining based on time and location of the mobile device whether to share the location information with at least one other device by:
determining whether location sharing with the at least one other device is enabled at a current time;
determining whether the mobile device is in a vicinity of a particular device of the at least one other device; and
determining that the location information is to be shared with the at least one other device only if the mobile device is in the vicinity of the particular device and location sharing is enabled at the current time.

16. The mobile device of claim 13, further comprising:
a user interface configured to receive user input for defining a set of rules for sharing the location information as a function of time and location of the mobile device; and
a memory for storing the set of rules;
wherein the time and location-based location sharer is configured for determining based on time and location of the mobile device whether to share the location information with at least one other device by:
determining based on the set of rules whether to share the location information with the at least one other device.

17. A server comprising:
a processor; and
a time and location-based location sharer configured for:
determining location information of a mobile device;
determining based on time and location of the mobile device whether to share the location information with at least one other device; and
sharing the location information with the at least one other device if so determined.

18. The server of claim 17, wherein the time and location-based location sharer is configured for determining based on time and location of the mobile device whether to share the location information with at least one other device by:
determining whether location sharing with the at least one other device is enabled at a current time;
determining whether the mobile device is in a vicinity of a location of interest; and
determining that the location information is to be shared with the at least one other device only if the mobile device is in the vicinity of the location of interest and location sharing is enabled at the current time.

19. The server of claim 17, wherein the time and location-based location sharer is configured for determining based on time and location of the mobile device whether to share the location information with at least one other device by:
determining whether location sharing with the at least one other device is enabled at a current time;
determining whether the mobile device is in a vicinity of a particular device of the at least one other device; and
determining that the location information is to be shared with the at least one other device only if the mobile device is in the vicinity of the particular device and location sharing is enabled at the current time.

20. The server of claim 17, wherein the time and location-based location sharer is further configured for:
receiving information defining a set of rules for sharing the location information as a function of time and location of the mobile device; and
storing the set of rules on the server;
wherein the time and location-based location sharer is configured for determining based on time and location of the mobile device whether to share the location information with at least one other device by:
determining based on the set of rules whether to share the location information with the at least one other device.
